(19) United States
(12) Patent Application Publication
(10) Pub. No.: US 2022/0400319 A1
(43) Pub. Date: Dec. 15, 2022

(54) Computer-implemented method for telling a Story through sequential layers by an Artist

(71) Applicant: Krystof Bernat, Ondrejov (CZ)

(72) Inventor: Krystof Bernat, Ondrejov (CZ)

(21) Appl. No.: 17/343,867

(22) Filed: Jun. 10, 2021

(51) Int. Cl. H04N 21/81; H04N 21/439; H04N 21/258; H04N 21/442

(52) U.S. Cl. CPC H04N 21/8106; H04N 21/4394; H04N 21/25816; H04N 21/44213

(57) ABSTRACT

The present invention relates to a computer-implemented method for Story-telling by The Artist. The method comprising uploading and/or creating media content to and/or by a first computer device by The Artist; sending one or more medial content from the first computer device to a remote server through one or more methods of communication, wherein said one or more media content forms a unit of The Story provided by The Artist; dividing said unit Story into at least three layers, wherein each layer is configured to represent a moment in The Story; and wherein the first layer comprises a first part of the media content, wherein the first part comprises an introduction of The Story; and the second layer comprises a second part of the media content; and the third layer comprises a third part of the media content, wherein the third layer comprises at least one final scene of The Story; and accessing to the divided content by a Visitor by means of a second computer, wherein the second computer is accessing the media content comprised in at least the first layer from the remote server; and presenting the first part of the media content on the second computer.

### TECHNICAL FIELD

The present invention relates generally to a computer-implemented Story-telling method, and more particularly to a Story-telling method that utilizes uploaded and/or created media content, wherein the media content forms a unit of The Story. The unit of The Story is subsequently separated into at least three layers of The Story, wherein the first layer comprises an introduction of The Story and the last layer comprises at least one final scene.

In an embodiment of the present invention, a Visitor is capable to change a Storyline or a Story-tone with the meaning of change the feeling of the scene if Artist of the content allows so, wherein The Story is told in order to provide maximum entertainment and/or educational benefit, e.g. based on their feelings in any time of The Story-telling method according the present invention.

### BACKGROUND OF THE INVENTION

Telling stories is a timeless method of entertaining, informing the public and educating. Stories have been crucial to our survival since the beginning of humankind. The Story is what allowed us to envision the future and so prepare for the unexpected. The Story is how we make sense of the world. For writers, the real breakthrough is discovering what triggers that sense of pleasure we feel when a Story hooks us. The trigger of all stories is curiosity. In other words, the desire to find out what happens next. That feeling of pleasure, it is a rush of the neural transmitter dopamine. It is our brain's way of rewarding us for following our curiosity until we find the answer. A Story is how what happens affects someone who is in pursuit of a difficult goal and how he or she changes as a result. What happens, that is the plot. Someone, that is the protagonist. The goal is what is known as The Story problem or Story question. And how he or she changes as a result, that is what The Story is actually about. A Story is about how the plot affects the protagonist. In other words, Story is internal not external. However, the most common computer-implemented Story-telling method is provided via social media, such as post including textual and/or graphical content, video content and/or multimedia content. For all of the computer-implemented Story-telling method, a definite media content is uploaded and without means of changing a Storyline based on the feeling of The Visitor. The entire media content is then available to The Visitor for free and/or as a paid content.

A three-act structure divides a Story into three separate sections, each anchored around one or more plot goals that drive the overall action. It is designed to help the audience and the writer create The Story and the drama. In The First Act., there is the main character who wants something; in The Second Act, he is trying to get what he wants, and in The Third Act, The Story reveals whether or not he succeeds. The First Act. is called build-up, setting the drama for The Story by introducing the protagonist, establishing his Status Quo, then upsetting that Status Quo and forcing this person to leave their Comfort Zone and go on an adventure. The Second Act is the Adventure. This is where the protagonist, and all characters, is trying to get what he wants. Obstacles, including themselves and each other, get in the way. The Second Act is full of conflict. After several Twists and Turns, the protagonist finally realizes what must be done to resolve that conflict, which is why The Third Act is called The Resolution. This is where the characters engage in a final decisive confrontation with each other. The results of that confrontation bring The Story to The Story Event.

Stories in state-of-the art Story-telling methods by the individual Artists are stagnant, i.e., The Story characters, plot lines, and ending do not change and cannot evolve based in The User feelings. Thus, The Visitor has to follow The Story-line told by The Artist typically presented in one particular way. In certain point, however, the feeling of The Visitor may change based on and The Visitor's past experience but according to the state-of the art Story telling method, they cannot decide to change the final ending. Thus, the content is not personalized with respect to The Visitor.

In view of the above-mentioned drawbacks, more personalized content presented to a Visitor, by an Artist, is thus a long term need and object of the present invention. There exists a long-felt need to allow Visitors to express themselves more freely and/or to choose personalized way of a personalized media content provided by an Artist.

### BRIEF SUMMARY OF THE INVENTION

Embodiments of the invention are defined by the claims. An overview of various aspects of the invention are provided here for reason of explanation of the invention, and to provide an overview of the disclosure, and to introduce a selection of concepts that are further described in the detailed description chapter below. This summary is not intended to identify key features or essential features of the claimed subject matter.

The present invention describes, among other things, a computer-implemented method for telling a Story through sequential layers by an Artist through computer-based technologies, wherein the method includes the steps as appended in the claims. The method steps are performed by processors of at least two computers and a remote server. In various embodiments, the computer-based technologies may comprise aspects of a platform, which includes hardware components, software components, and related services and applications directed to providing a media content, such as visual and/or audio content. The audio content, as a preferred embodiment, represents a part of a whole Story told by a musician. The form of The Story can be preferably a single track, or an album of the tracks provided by one or more musicians. In another embodiment, the present disclosure is capable to upload and/or create and provide a dynamic Story, in particular a dynamical audio Story telling experience for a Visitor, wherein The Visitor may in some aspect influence The Story line-up subject to their decision based on their feelings, for example. In more preferred embodiment of the method according to the present invention, it is provided function which enables a Visitor to change a Story-line or a Story-Event. In yet another embodiment, the method for creating the media content enables The Artists to create shared content between The Users.

A better understanding can be provided with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE VIEWS OF THE DRAWING

FIG. 1 shows a diagram corresponding to a first embodiment of the present invention, wherein the diagram represents the steps of the method.

FIG. 2 shows a diagram corresponding to a second embodiment of the present invention, wherein the diagram represents the steps of the method especially suitable for musicians.

FIG. 3 shows a diagram corresponding to a third embodiment of the present invention, wherein the diagram represents the steps of the method providing further details on acts divided into three layers.

FIG. 4 shows a diagram corresponding to a fourth embodiment of the present invention, wherein the diagram represents the steps of the method and areas of the media content comprised in layers, wherein an access to the media content is subject to administrator permission.

FIG. 5 shows a diagram corresponding to a fifth embodiment of the present invention, wherein the diagram represents the steps of the method, wherein several options of act III containing final scene is provided.

FIG. 6-a shows a diagram corresponding to details of the fifth embodiment further provided by variety of Story Events resulting into different final scene of The Story telling method.

FIG. 6-b shows a diagram corresponding to details of the fifth embodiment further provided by variety of Story Events of The Story telling method, wherein a plurality of option is provided in accordance with The Visitors' decision.

FIG. 7 shows a diagram corresponding to an embodiment of the present invention, wherein the diagram represents the steps of the method, wherein The Artist may access to a database comprising media content of a further Artist.

FIG. 8 shows a diagram corresponding to another embodiment of the present invention, wherein the diagram represents the steps of the method, wherein a layer comprises a several media content and wherein, optionally, an Artist may include a further Artist's creative art stored in a database.

FIG. 9 shows a diagram corresponding to another embodiment of the present invention, wherein the diagram represents the steps of the method, wherein a layer comprises a several media content and wherein, optionally, a further Artist may approve or decline inclusion of the further Artist's creative art.

### DETAILED DESCRIPTION OF THE INVENTION

The method according to the present invention and described herein relies preferably on the art of music for many of the examples on the preferred embodiments but is not limited solely to the field of music art. It should be noted that the system can be used in almost any area of the creative arts including but not limited to, literal art such as books, novels, blog posts, plays and other literature, video, film, television broadcast, music videos, still photography, podcasts, live concerts, theatre, ballet, opera, prints to name a few media content. The method according to the present invention is intended to generate a Visitor's personalized media content.

The present invention is described below with reference to block diagrams and operational illustrations of method steps. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer, special purpose computer, or other programmable data processing apparatus, such that the instructions, which are executed via the processor of the computer or other programmable data processing apparatus, implements the functions/acts specified in the block diagrams or operational block or blocks.

In some mode of the operation, the steps noted in the blocks of any of the block diagrams can occur out of the order noted in the operational illustrations. For example, two blocks shown in succession can in fact be executed subsequently or another step or steps can be inserted between two blocks, depending upon the functionality involved. Furthermore, the embodiments of methods presented and described by means of diagrams in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In general, terminology may be understood at least in part from usage in context, For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristics in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As herewith defined, a computer can be a state-of-the-art, preferably User-friendly, personal computer, or a mobile phone, tablet, smart watch or smart googles or any other means capable of accessing to a network, uploading and/or downloading from a network and displaying particular media content, wherein the computer is in communication with a remote server over a network, such as wireless or wire connection to a local area network (LAN)/wide area network (WAN), such as the Internet. The network may couple devices so that communications may be exchanged, such as between a server and a User's device or other types of devices, including between wireless devices coupled via a wireless network, for example.

A network may also include the mass storage device, such as network attached storage (NAS), a storage area network (SAN), or other forms of computer or machine-readable media, for example. A network may include the Internet, one or more local area networks (LANs), one or more wide area networks (WANs), wire-line type connections, wireless type connections or any combination thereof. Likewise, sub-networks, such as may employ differing architectures or may be compliant or compatible with differing protocols, may interoperate within a larger network. Various types of computers as mentioned above may, for example, be made available to provide an interoperable capability for differing architectures or protocols. As one illustrative example, a router may provide a link between otherwise separate and independent LANs. Although mentioned-wireless network and WAN/LAN, The User's device can communicate with the remote server via any type of network.

As herewith defined, a User is a person who utilizes the computer as mentioned above. Users of the computer implementing the method according to the present invention may, in general, lack the technical expertise required to fully understand the spirit of the present invention since they are mainly using functionality provided to them, preferably by graphical User interface. More preferably, The Users can use a web browser, wherein the method according to the present invention is performed on the network, more preferably the Internet, and functionalities of the method are implemented into a software application. The User can be an Artist or a Visitor.

An Artist is herewith defined as a person creating or uploading the media content comprising at least part of creative art as defined above. In some embodiment, The Artist may be able to access e-commerce and advertiser relationships and statistical data on Visitors.

A Visitor is a person accessing and subsequently consuming the media content created and/or uploaded by The Artist. A Visitor can be an anonymous Visitor, identifiable Visitor, e.g. identifiable only by IP address at a given time or identifiable by login and password. Visitors may, in general, view and search media content, but they may not create content as such. In some embodiment, once The Visitor wishes to create and/or upload media content, they become an Artist with the meaning of the present invention.

In some embodiment, a User (an Artist and/or a Visitor) is subject to authentication. All authenticated Users may have public profiles created upon account creation. These profiles may be located and accessible via the web-form platform or other software applications. User profiles may act as the list for a variety of media content integrated in The Artist Story-telling environment. The Artist profile may allow other Users to link and/or adopt and/or create shared layer of media content from other Artist's account and create a repository of their content available for them to draw on during The Story creation method according to the present invention.

As herewith defined, a first computer is operated by an Artist creating and/or uploading media content into a remote server. The first computer may be capable of sending or receiving signals, such as via a wired or wireless network, or may be capable of processing or storing signals, such as in memory as physical memory states, and may, therefore, operate as a server as well. Thus, any device capable of operating as a server may include, as examples, personal desktop computers, laptop computers, tablets. The first computer can be operated based on operating systems, such as Windows Server, Mac OS X, Unix, Linux, FreeBSD, or the like. The first computer is configured to transmit a media content to the server as a unit of a media file. In some preferred embodiment, the first computer further comprises hardware and/or software for creating or editing media content, such as microphone for recording an audio, or any digital audio workstation software, etc.

As herewith defined, a second computer is operated by a Visitor accessing the media content from the server. The second computer may be capable of sending or receiving signals, such as via a wired or wireless network, or may be capable of processing and/or transmitting signal to a server in order to access into Artist media content. Thus, the second computer may include, as examples, personal desktop computers, laptop computers. The first and the second computer can be operated based on operating systems, such as Windows Server, Mac OS X, Unix, Linux, FreeBSD, or the like.

As herewith defined, a remote server can be computer containing uploaded media content forming a unit of a Story, a Story-line or Story-lines. In someone aspect, a remote server including logic for communicating a software application, preferably a website application, from a first computer operated by an Artist to a second computer operated by a Visitor. The remote server can be operated by an administrator, wherein the remote server is configured to perform steps according to the present invention via receiving instructions from both, the first and the second computer and allowing to display the media content by the second computer. The remote server, in particular, may contain a database of creative arts, as mentioned above. In some embodiment, the remote server can be also in communication with an advertisement server, which may provide one or more advertisements to the second computer upon the request of the administrator of the remote server or upon the request of The Artist. In another embodiment, The Visitor may send a request to the remote server for advertisement free media content. The advertisement free media content may be subject to permission by an administrator. The administrator has the ability to administer various aspects of the system, commit code, delete content as whole or partly or delete an advertisement, manage databases, and enable/disable various functionalities on the system operated in accordance with the invented method. Examples of devices that may operate as a content server include desktop computers, multiprocessor systems, microprocessor-type or programmable consumer electronics, etc. Content server may provide a variety of services that include, but are not limited to, web services, third-party services, audio services, video services, email services, instant messaging services, voice over IP (VOW) services, photo services, social media services, statistical data services or the like. Examples of content may include text, images, audio, video, or the like, which may be processed in the form of physical signals, such as electrical signals, for example, or may be stored in memory, as physical states, for example. In one embodiment, the first computer operated by The Artist hosts or is in communication with a database comprising Artist work.

As herewith defined, a database is a collection of media content of creative art as defined above. The database may further contain information on Users. The media content and information on The Users can be organized so that it can be easily accessed, managed and updated. Computer databases can further contain aggregations of data records or files, containing information about sales transactions or interactions with specific customers and further statistical data. The administrator is, in general, the only one who may access the information on the database without any restriction. The Users may also access into the database upon administrator permission and upload and/or create and/or display the media content stored thereon.

As herewith defined, a processor receives media content and/or instruction from a first computer operated by an Artist and transmit the media content to the second computer operated by The Visitor. In some embodiment, the processor also receives instruction from the second computer operated by The Visitor sending a request allowing access to a protected area to an administrator. The processor may edit selected media content stored in the database and fit the media content into an Artist's layer. In an embodiment, the processor may create a mixed-media content including the plurality of layers organized into a desired sequence for The Story. In one embodiment, the processor may analyze and/or receiving instruction associated with behavior of The Visitor or their feelings. The processor can also analyze the media content in The Story-line and determine the desired sequence for the selected layer. In some embodiment, the processor can obtain, from the second computer operated by The Visitor, instruction regarding to The Story telling line-ups. In an embodiment, the analyzing includes receiving from input form the second computer operated by The Visitor requesting a selection of the media items to be changed and/or replaced in a layer so that the selection corresponds to the behavior and/or feelings of The Visitor. Alternatively, the analyzing includes automatically determining the media items personalized for The Visitor. In one embodiment, each media item is one or more of digital photographs, a sound, music, a video, a graphic, an animation or mixture thereof, most preferably the audio content by the musician.

As herewith defined, a layer is a single unit organization of programming comprising separate media content which may interact in some sequential and hierarchical way, wherein each layer can be provided with an interface presenting the media content in particular way, for example, audio can be stored in the layer in mp3 format alike or video can be stored in mp4 format alike and/or literary content can be stored in html format or pdf format alike. Each layer may further comprise a decision algorithm for connecting at least two layers. Communication programs are often layered comprising a media content or plurality of media content. The layer may include, for example, a first media content from the first Artists, the second media content from the second Artist, accompanied music from the third Artist, and/or a graphical art from the fourth Artist. The unit of The Story is separated into at least three layers according to the present invention. In one embodiment, the processor and/or Artist determines a length of the mixed-media module and may divide it into more than three layers. The Story-telling method according to the present invention may have various media content specifications including feature pages that act as introducing page(s) comprising a media content available to all Visitors. The layer may be further accompanied by name of The Artist, an image of The Artist, origin of The Story, description of Story background, related Story, etc. The layers may use a display “image” and/or “literal” stories selected by The Artist based on taxonomy or interest of The Visitor. Alternatively, the layer may play an audio or video in certain Story context subject to Artist's Story-telling method according to the present invention and optionally subject to Visitors' intervention. In some embodiment, the layer may be accompanied by advertisements and/or lists that direct Visitors to other featured stories or sponsored media content relating to further stories. In some embodiments, the layers and connected media content can be a webpage(s), which display the media content formatted in common ways, assembled to maximize exposure to relevant related content, including advertising. The layers are composed one at a time, with a User choosing to “create a Story line-up” with the customized final scene. The Visitor pages include but are not limited to, the media content created by The Artist and optionally advertisement since the administrator may receive a request for removing the advertisement thereof. In some embodiment, each type of media content can be displayed on a separate layer as a webpage and The Story may also have a page that has a plurality of the layers comprising different media types on the page or multiple pages wherein each of the multiple pages has a plurality of the different media content types on the each page.

The Storyline tends to have a certain rhythm. Specific elements fill this rhythm, and characters' global status and temporary statuses are shifting throughout The Story. The present invention uses the escalating cause and effect progression of external events constructed to force the protagonist to deal with his inner issue: what he wants, why he wants it, and the longstanding fear that he′ll have to overcome to get it. In certain embodiment, the protagonist can be an Artist. Only then he can solve The Story problem. The Story is divided into at least three layers comprises at least three acts.

The First Act is known as The Buildup. Since stories are about somebody pursuing a challenging goal and how the protagonist changes (how the plot affects the protagonist), we need to know him. The audience needs a solid understanding of what the protagonist wants, what it means to him, and what longstanding fear he has to overcome to have a shot of success. So the critical element of the beginning is the protagonist's Status Quo, meaning the current state of affairs, characters' desires, strengths, weaknesses, and knowing how the protagonist sees the world. Additionally, the beginning can provide information (Exposition or Prolog) about the life around, opening or supporting a Story or backstory. Then, the Routine Killer event (aka Call to Adventure, Inciting incident, or Unexpected event) destroys the protagonist's status quo by sudden and unexpected pieces of information, introduces the first plot twist, and opens a so-called Story problem. The protagonist has an inner issue: an internal conflict or belief that's holding him back and that he must deal with and overcome to achieve his goal. By taking time to think about the next steps, the protagonist handles the Timeout event (also called “Second Thoughts”). It reveals the protagonist's hesitation to proceed with The Story, creates drama, and has a unique opportunity to understand how difficult it is for him to leave the comfort zone. He preferably overcomes Early obstacles and gets rid of those one at a time by Early Solutions. Then there is only one final scene in The First Act., and that's The Leaving the comfort zone scene. Here is where the protagonist realizes that The Second Act is inevitable.

The Second Act can be selected from the group consisting of: confrontation, conflict, journey or adventure. The first scene, Beginning of Adventure, binds The Story to a new direction, preferably contrasting with The First Act., giving the protagonist a little time to adjust. However, the H-hour is an event provides a literal first step of resolving The Story problem. The protagonist is trying to accomplish his Story problem, but there is a big pile of Obstacles in the way. The Second Act is about the protagonist trying to conquer an obstacle, coming across a new one, or briefly celebrating his victory over the last. Fortunately, the protagonist can learn something from all the obstacles he overcame and learn something therefore he obtains Payoffs, he didn't know initially. Along with all the obstacles, The Second Act is divided into four major plot twists: 1st plot thickener, the Halfway point, Crisis, and Great revelation, also known as Aha! Moment. 1st Plot Thickener scene makes The Story intensive for the protagonist by raising The Story's stakes and reminding the seriousness of the adventure. The protagonist is now well into adventure and knows his mission, but The Halfway Point changes it up and spins The Story around in a surprising and significant way. But because the protagonist has so many unresolved conflicts, the 2nd plot thickener deepens the conflict into a Crisis. After Crisis, the Great Revelation scene puts the protagonist in a position to resolve The Story problem by enlightening the final path ahead.

In the last part of The Story, the protagonist is delivered into The Story climax by The Third Act's opening scene Preparing for Resolution, preferably contrasting with the previous one as much as possible. After that, the protagonist has to face the last great test of his will and fight for what he wants. The Climax, also known as decisive confrontation, is the scene that leads to The Story Event, establishing a new status quo for all the characters in a Story. It might contain the Payoffs from The Second Act. And because great stories are about how the protagonist changes, The Story Event is what The Story is actually about. After that, the audience deserves a moment to look back on everything that's just happened and see the characters reacting to their new status quo. If the scene takes place right after The Story Event, then it's The Aftermath. If it takes place a long time later, then it's The Epilogue.

As herewith defined, an area available to all Visitors is generally meant as the part of the platform which does not require any authentication sent by the second computer operated by The Visitor. The area available to all Visitors may comprise a first layer, preferably including the introduction of The Story, without any authentication and/or permission by an administrator.

As herewith defined, a protected area is an area comprising layers and corresponding media content that is not normally visible to a Visitor. Once, The Visitor wishes to access the protected area and corresponding layers with media content, they may request an administrator for allowance to access thereto.

The Story-telling method according to the present invention may also has alternative final scene stored in a database. The alternative final scene may be subject to Visitor's request, preferably based on their feelings, or subject to behavior of The Visitor on the platform. Each Story-telling final scene may correspond to media content associated with corresponding feelings. In some embodiment, The Story telling method is designed to be displayed in following steps 1) letting The Visitor to access to the first layer comprising a first part of The Story, optionally on a webpages; 2) letting The Visitor to access the second layer comprising the second part of The Story provided The Visitor sent a request to the administrator and the administrator permit the access to the second layer, wherein preferably the first and any subsequent layers are free of advertisement after the permission and 3) displaying the media content on several layers, optionally with plurality of Story Events and final scenes.

In some embodiment, some media content comprised in layers under protected area may be only visible within User profiles and may be kept separate from first layer of The Story. A second, third and any subsequent layer, if any, may be treated as a single layer comprising media content connected to Story, whose media content is presented in sequence and according to administrator permission. Unlike a unit of The Story, the layer separates the unit of The Story into following and subsequent Story Event.

The Story-telling system adopting the method according to the present invention has a Story architecture. A “Story Event” which can be considered as the equivalent of a chapter book and is composed of a group of stories, separated into “Story Parts.” For example: a Story layers with six chapters would be a six-part Story layers, made up of Part 1, Part 2, Part 3, etc. in accordance with the three act structure as defined above. A User should be able to start a Story line or be able to assign an existing Story, that they have created, to a Story layers whenever they want. Users can have the ability to modify a Story layers hierarchy at their will. A layers can only be published if it is attached to two or more stories that also are published. Preferably, this Story-telling system can work as a musical platform for an Artist to tell stories with their music.

The process of creating a Story by an Artist can be managed through a set of proprietary processes and methods that: Create a Story framework; Add a layer; Sort layers according to The Story framework model; Present layers in a specific order, Present Story parts to different Users based on their editorial roles (i.e. Users can edit stories; but The Visitor can modify stories in certain level of degree of freedom relating to the context of The Story).

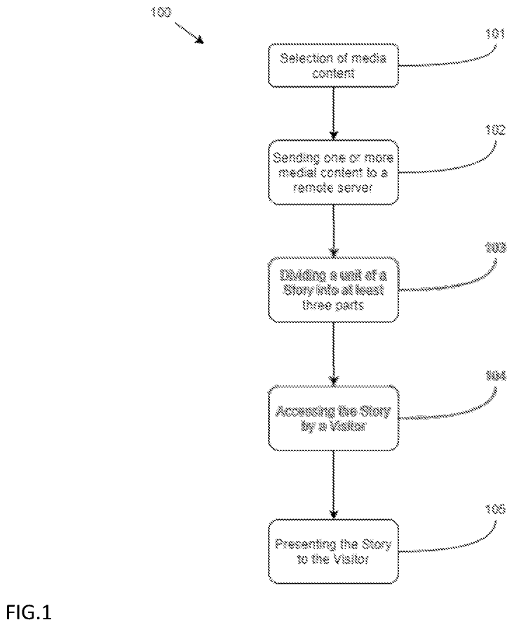

FIG. 1 shows a diagram 100 detailing a possible mode of operation of a method for uploading and/or creating the media content of creative art provided by an Artist. It should be noted that the term “item of creative art” should be taken in the broadest sense as described above. Each of these may be considered a different class of the creative arts and each class may have many subsets that may also be known as genres for that class of creative art. In Step 101, an item of the media content is selected to be uploaded and/or created based on the already uploaded media content. The diagram then branches to step 102. In step 102, The Artist sends the one or medial content from the first computer device to a remote server via one or more methods of communication. (The term “medial content” encompasses any content that may be embodied in a fixed medium such as a sound recording, visual representation, video or still-frame images, haptic or olfactory content.) The method of communication can be for example, but not limited to, internet connection or Ethernet connection or any computer-based network comprising a first computer, a remote server and a second computer, wherein at least one is a transmitter and the at least one is a receiver. By uploading and/or creating the media content onto the remote server, a unit Story is thereby provided. The diagram then branches to step 103. In step 103, The Artist proceeds with the instruction to divide the unit of The Story into three layers. Each layer has one or more their media content. The layers of The Story are at least three layers. The first layer comprises an introduction part of The Story. In some advantageous embodiment, the first layer may comprise media content in accordance with The First Act. The second layer may comprise further evolution of The Story in accordance with The Second Act. The third layer comprises at least one final scene in accordance with The Third Act. The diagram then branches to step 104. In step 104 a computer-implemented method allows a Visitor to access into the media content of the first layer, wherein The Visitor is using a second computer connected to the remote server. The method further continues to step 105. In step 105, the media content of the first layer is presented to The Visitor.

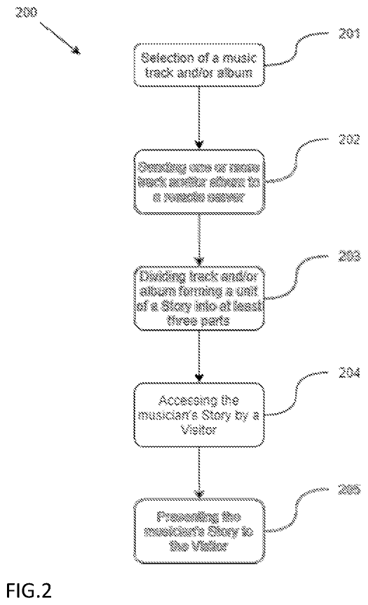

FIG. 2 shows a diagram 200 detailing a possible mode of operation of The Story-telling method illustrated in FIG. 1 specifically as it relates to music. This is defined as the method wherein the musician can upload and/or create a music track or an album onto a remote server via a first computer. In step 201 a specific music track and/or album is selected by The Artist for upload and/or creation. The diagram then branches to step 202. In step 202, the track and/or album comprising musical content are uploaded to the remote server and stored therein. The diagram then branches to step 203. In step 203, the selected track/album with the musical content are separated into at least three layers. The diagram then branches to step 204. In step 204, the computer-implemented method allows a Visitor to listen track/album at least of the first layer. If the administrator allows, The Visitor is further enabled to listen music in the diagram branches towards to step 205. In step 205 the administration may allow listening of the track and/or album associated with the musician that meet certain quality criteria and from which future recommendations will be made.

In more preferred embodiment, the media content according to the present invention is an audio content. Preferably, an Artist may create a Story comprising at least three tracks. The first track is the track according to The First Act. The second track may be provided with plurality of alternatives, such as a classic version, jazz-version, rock-and-roll version, etc., which correspond to The Second Act. The Visitor may choice, based on their feeling, the appropriate version of the track. The third track may correspond to The Third Act of the present invention. The third track can be only one version. In another preferred embodiment, the third track can have a plurality of versions depending on a choice according to The Second Act. In some examples, the jazz version chosen in The Second Act will result into jazz version of a track in The Third Act. All of the above-mentioned tracks are comprised in the three layers as substantially herewith described, in particular (non)-restricted area for access by the Visitors. It should be appreciated, that The Artist may provide more than three tracks, such as four, five, six, etc. and their alternatives. The Artist may subsequently decide to include: the first and the second track into a first layer corresponding to The First Act.; the third and the fourth track into a second layer corresponding to The Second Act and the fifth song into the third layer corresponding to The Third Act.

In alternative embodiment, the media content according to the present invention is an audio content. Preferably, an Artist may create a Story comprising at least three tracks. The first track may be provided with plurality of alternatives, such as a classic version, jazz-version, rock-and-roll version, wherein the first track is the track according to The First Act. The Visitor may choice, based on their feeling the appropriate version of the track in The First Act. The second track may be provided with plurality of alternatives, such as a classic version, jazz-version, rock-and-roll version, etc. The Visitor may choice, based on their feeling, the appropriate version of the track in The Second Act. The third track corresponds to The Third Act of the present invention. The third track can be only one version. In another preferred embodiment, the third track can have a plurality of versions depending on a choice according to previous choice. In some examples, the jazz version chosen in the previous choice will result into jazz version of a track in The Third Act.

In an example, Users are able to create original content for the platform or use their past works.

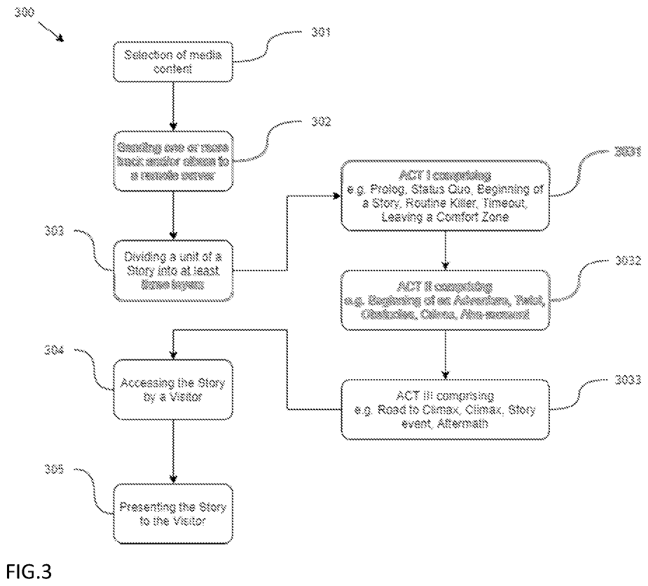

FIG. 3 shows a diagram 300 detailing a possible mode of operation of the method according to the present invention, wherein the step of dividing a unit of a Story into at least three layers is provided. In Step 301 an item of the media content, preferably the musical content such as a track and/or album is selected to be uploaded and/or created based on the already uploaded media content. The diagram then branches to step 302. In step 302, The Artist, preferably musician, sends the one or more uploaded and/or created medial content from the first computer device to a remote server via one or more methods of communication. By uploading and/or creating the media content onto the remote server, a unit Story is thereby created. The diagram then branches to step 303. In step 303, The Artist proceed with the instruction to divide the unit of The Story into at least three layers 3031, 3032 and 3033. Each layer 3031, 3032 and 3032 has one or more their media content. The first layer comprises an introduction part of The Story. In some advantageous embodiment, the first layer may comprise media content in accordance with The First Act. The media content comprised in the first layer shall be understood with the broadest sense as possible. The media content is, e.g. a literal content in the first layer introducing The Artist's view on certain topic. The first layer 3031 may further comprise an audio file accompanying the literal content. The first layer 3031 may further comprise a video file accompanying the literal content. In another embodiment, the first layer 3031 may contain only a part of the media content, such as a video file in accordance with The First Act. The second layer may comprise a further evolution of The Story according to The Second Act. The second layer may comprise a second part of the medial content, such as the second part of the video file. In another embodiment, the second layer may further comprise another media content such as a second literal content as a whole, e.g. a second chapter of the book. In yet another and preferred embodiment, the second layer may further comprise a second track of a musician album. The third layer comprises at least one final scene. The third layer may be further divided into further layers containing further media content such as described above. The third layer may comprises media content according to The Third Act. The First Act, The Second Act and The Third Act comprises scenes as substantially described above. The diagram then branches to step 304. In step 304 a computer-implemented method allows a Visitor to access into the media content of to the first, second and third layer depending on administrator permission. The method further continues to step 305. In step 305, the media content of the first layer is presented to The Visitor. In one embodiment, the media content of the first layer is presented to The Visitor without any restriction to authentication, so called area available to all Visitors according to the present invention. The second and any further subsequent layer may be accessible subject to authentication and upon the permission by the administrator.

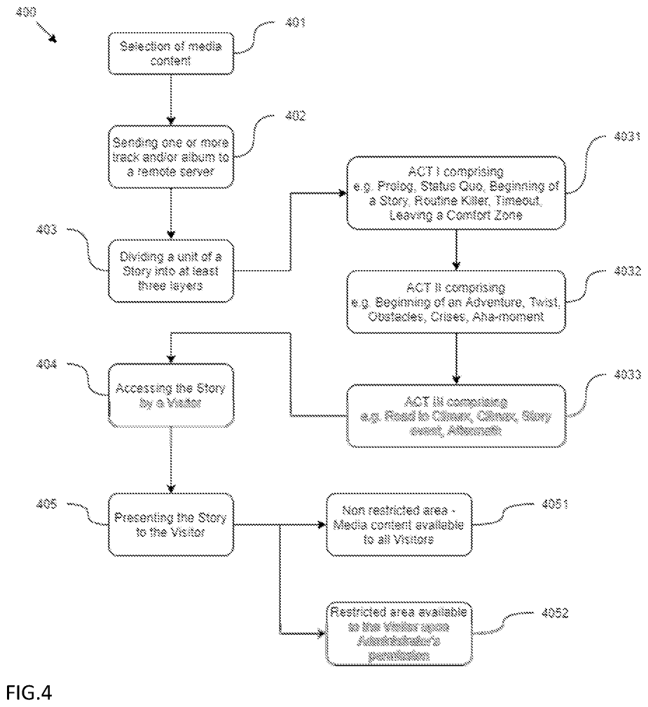

FIG. 4 shows a diagram 400 detailing a possible mode of operation of the method according to the present invention, wherein the step of dividing a unit of a Story into at least three layers is provided and The Story is presented in two areas subject to permission of the administrator. In Step 401 an item of the media content, preferably the musical content such as a track and/or album is selected to be uploaded and/or created based on the already uploaded media content. The diagram then branches to step 402. In step 402 The Artist, preferably musician, sends the one or medial content from the first computer device to a remote server via one or more methods of communication. By uploading and/or creating the media content onto the remote server, a unit Story is thereby created. The diagram then branches to step 403. In step 403, The Artist proceed with the instruction to divide the unit of The Story into at least three layers 4031, 4032 and 4033. Each layer 4031, 4032 and 4033 has one or more their media content. Each layer 4031, 4032, 4033 may be subject to special permission of the administrator such that, the media content will be shown in restricted area of the platform. In some embodiment, the method may further comprises a step for checking the type of the area, which The Visitor wishes to access. In some embodiment, the first layer comprises an introduction part of The Story. In some advantageous embodiment, the first layer may comprise media content according to The First Act. The media content comprised in the first layer can be substantially the same as described above. The media content of the first layer may not be subject to any of the administrator permission, and thus, can be accessible to anyone. The second layer may comprise a further evolution of The Story according to The Second Act. The second layer may comprise a second part of the medial content as substantially described above. The second media content comprised in the second layer may be subject to the administrator permission. Thus, the second content is not available to public at the beginning. The administrator permissions is connected to The Visitor and/or The Story framework, which may allow The Story to be edited, published, deleted, or simply viewed in its whole media content or at least one part of the media content stored in at least one layer. The third layer comprises at least one final scene. The third layer may be further divided into further layers containing further media content such as described above. The third layer may comprises media content according to The Third Act. The diagram then branches to step 404. In step 404 a computer-implemented method allows a Visitor to access into the media content of to the first, second and third layer depending on administrator permission. The method further continues to step 405. In step 405, the media content of the first layer 4031 is presented to The Visitor. In another embodiment, the first layer 4031, the second layer 4032 and the third layer 4033 is presented to The Visitor subject to administrator permission. Each layer can be presented, e.g. displayed or played, in non-restricted area 4051 available to all Visitors or in a restricted area 4052 available to Visitors upon administrator permission. The non-restricted are 4051 can be further provided with advertisement and/or sponsored content. The restricted area 4052 is preferably without the advertisement and/or sponsored content. The Visitor not having permission by the administrator may not access to the restricted area and thus, they do not have any access to the media content in the layer 4032 or 4033 stored in the restricted area 4052.

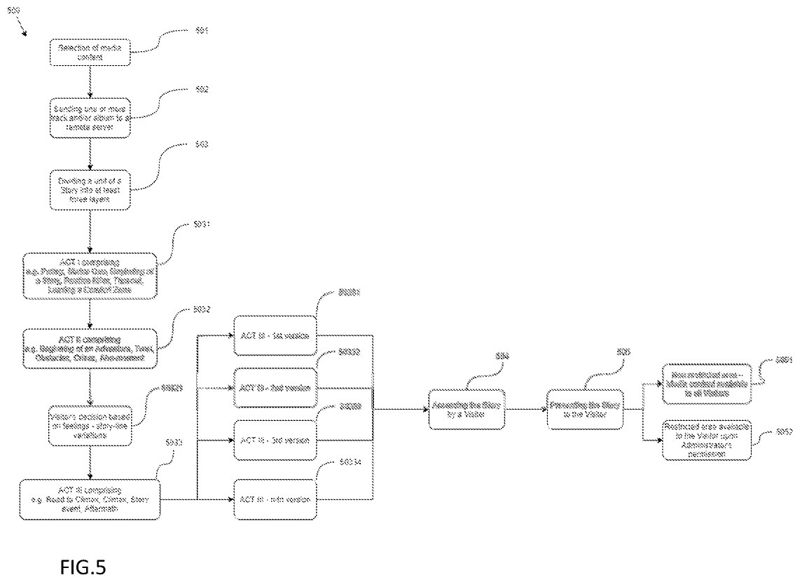

FIG. 5 shows a diagram 500 detailing a possible mode of operation of the method according to the present invention, wherein the step of dividing a unit of a Story into at least three layers 5031, 5032, 5033 is provided and The Story is presented in two areas 5051, 5052 subject to permission of the administrator and wherein alternative Story acts 50331, 50332, 50333, 50334 can be stored in a database corresponding to at least one layer resulting into plurality of final scenes. In Step 501 an item of the media content is selected to be uploaded and/or created based on the already uploaded media content. The diagram then branches to step 502. In step 502 The Artist sends the one or medial content from the first computer device to a remote server via one or more methods of communication. By uploading and/or creating the media content onto the remote server, a unit Story is thereby created. The diagram then branches to step 503. In step 503, The Artist proceeds with the instruction to divide the unit of The Story into at least three layers 5031, 5032 and 5033. Each layer 5031, 5032 and 5033 has one or more their media content as substantially described above. Each layer 5031, 5032, 5033 may be subject to special permission of the administrator such that, the media content will be shown in restricted area of the platform. In some embodiment, the method may further comprise a step for checking the type of the area 5051 and 5052, which The Visitor wishes to access. In the present example, the second layer 5032 comprises a request 50321 from The Artist to The Visitor to decide how The Story shall continue. The Visitor's decision can be stored in a database and The Story-line can change the further Story-telling in third layer 5033 comprising alternative acts 50331, 50332, 50333, 50334 corresponding to the decision. The decision can be based on Visitor's feeling, for example. The diagram then branches to step 504. In step 504 a computer-implemented method allows a Visitor to access into the media content of to the first, second and third layer depending on administrator permission. The method further continues to step 505. In step 505, the media content of the first layer 5031 is presented to The Visitor. In another embodiment, the first layer 5031, second layer 5032 and third layer 5033 is presented to The Visitor subject to administrator permission. Each layer can be presented, e.g. displayed or played, in non-restricted area 5051 available to all Visitors or in a restricted area 5052 available to Visitors upon administrator permission. The non-restricted are 5051 can be further provided with advertisement and/or sponsored content. The restricted area 5052 is preferably without the advertisement and/or sponsored content. The Visitor not having permission by the administrator may not access to the restricted area and thus, they do not have any access to the media content in the layer 5032 or 5033 stored in the restricted area 5052. In some embodiment, the decision 50321 and alternative acts 50331, 50332, 50333, 50334 can be also provided in the restricted area 5052. In some embodiments, the decision 50321 and ACT III— 1^{st} version or ACT III— 2^{nd} version is available in non-restricted area 5051, but ACT—III— 3^{rd} version 5033 and any other version of ACT—III 50334 can be provided in restricted area 5052.

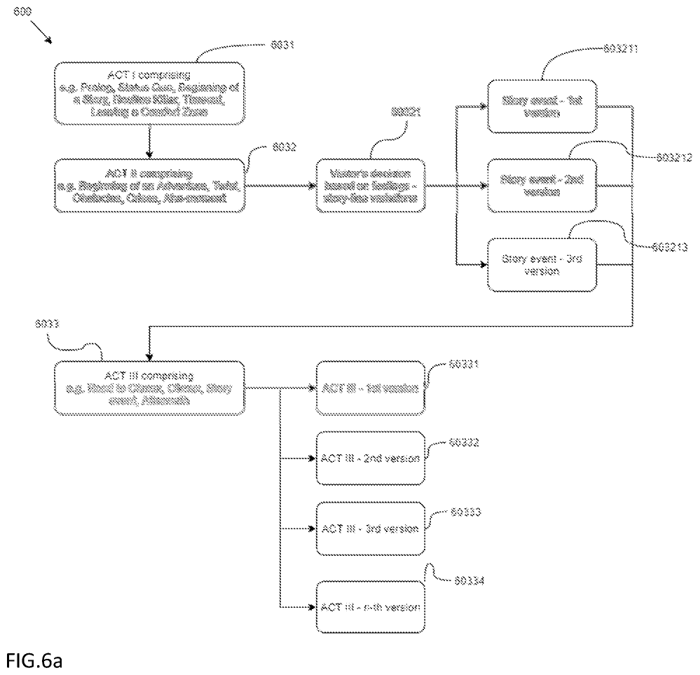

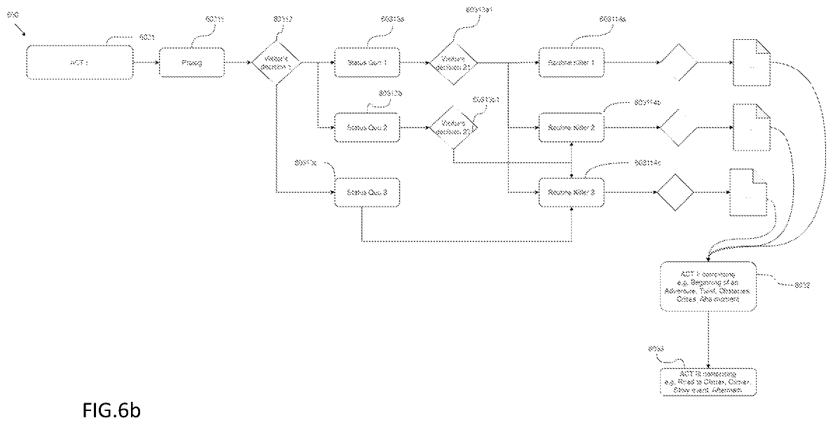

FIG. 6a shows a diagram 600 detailing a possible mode of operation of the method according to the present invention, wherein the step of dividing a unit of a Story into at least three layers 6031, 6032, 6033 is provided and The Story is presented in two alternative Story acts 60331, 60332, 60333, 60334 be stored in a database corresponding to at least one layer resulting into plurality of final scenes. Uploading and/or creating the media content onto the remote server, thereby creating a unit Story is substantially described in connection with FIG. 5. The Story is divided into at least three layers 6031, 6032 and 6033. Each layer 6031, 6032 and 6033 has one or more their media content as substantially described above. Each layer 6031, 6032, 6033 may be subject to special permission of the administrator such that, the media content will be shown in restricted area of the platform. In the present example, the second layer 6032 comprises a request 60321 from The Artist to The Visitor to decide how The Story shall continue. The Visitor's decision can be stored in a database and The Story-line can change so that, appropriate Story Event 603211, 603212, 603213 is provided in Story-telling corresponding to the decision. In some embodiment, the second layer 6032 may have plurality of the request for the decision 60321 so that, The Story evolves in accordance with the plurality of the decisions provided by The Visitor. The third layer 6033 comprising alternative acts 50331, 50332, 50333, 50334 corresponding to the decision(s) as mentioned above. The decision can be based on Visitor's feeling, for example. The method can substantially continue to the step 504 and 505 in accordance with the embodiment shown in FIG. 5. In some embodiment, The Visitor, upon his decision can choice a Story Event— 1^{st} version 603211 or 2^{nd} version 603212 or 3^{rd} version 603213 while The Story always result into the same final scene, such as ACT III— 1^{st} version 60331. Therefore, the variation is provided only in the second layer 6032. In more preferred embodiment, the media content is an audio album comprising at least three tracks and their alternatives. The first track is provided in The First Act. 6031. The second track has at least two alternatives, such as jazz and classic version. The Visitor, upon his decision 60321, can decide which alternative version 603211 or 603212 will be provided in The Second Act 6032. In some examples, the third track does not have any alternatives, thus independently of choice of The Story Event, The Story-line always result into the third track provided in act III 6033. In some another embodiment, the third track can be provided with the alternatives so that act III 6033 is dependent on the decision 60321 provided in act II 60321.

FIG. 6b shows the diagram 600 further detailing a possible mode of operation of a method comprising three Acts 60311, 6032, and 6033. The Act I 6031 stars with a Prolog 60311. The Visitor is therefore always presented to the Prolog 60311 by The Artist. The Story-telling method continues to a Visitors' decision 1 tree 60312, wherein The Visitor may decide an alternative of the Story Event. Preferably, The Visitor may decide upon their feelings. Via the decision 60312, The Visitor can then proceed to the alternative three Story Events, herewith shown as Status Quo 1 60313a, Status Quo 2 60313b and Status Quo 3 60313c. The Visitor, who has decided to lead The Story to Status Quo 1 60313a, can be further led to a further Visitor's decision 21 process 60313a1 that will affect other parts of The Story called as Routine Killer 1 603114a, Routine Killer 2 603114b, or Routine Killer 3 603114c. The Visitor, who in the previous step decided on The Story containing into The Status Quo 2, can be further led, based on a further Visitors' decision 21 tree 603133b1, only to Routine Killer 2 603114b, or Routine Killer 3 603114c. The Visitor, who decided for Status Quo 2 60313b cannot continue the Story according to part of the scenario to Routine Killer 1 603114a. Similarly, a Visitor, who decided The Story continuing in line Status Quo 3 60313c, is automatically guided, without further decision, to routine killer 3 603114c. The principle described above includes a plurality of alternative scenarios, the evolution of the whole Story depending on the decision of The Visitor. The Visitor can thus create their own customized Story designed by The Artist. FIG. 6b further schematically shows another possible continuation with other possible decision trees in the right part of the figure. However, The Story always continues to the Act II, which may also contain a number of these alternative scenes. The Story ends with Act III.

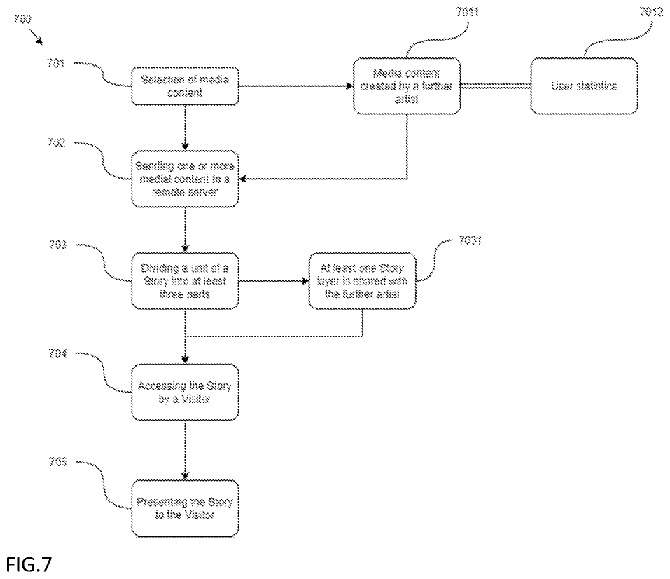

FIG. 7 shows a diagram 700 detailing a possible mode of operation of a method for uploading and/or crating the media content of creative art provided by an Artist. In Step 701 an item of the media content is selected to be uploaded and/or created based on the already uploaded media content. In the present example, the media content can be created media content provided by a further Artist 7011 upon request therefrom or upon request provided to the administrator. The media content provided by a further Artist 7011 can be available to them through a database. In yet another embodiment, the media content created by a further Artist 7011 can be subject to User statistics so that, the further Artist may track their creative work. The diagram then branches to step 702. In step 702 The Artist sends the one or medial content from the first computer device to a remote server via one or more methods of communication. By uploading and/or creating the media content onto the remote server, a unit Story is thereby provided. The uploaded Story may, in final, result into shared Story layer 7031, wherein at least one part The Story is share with the further Artist. The diagram then branches to step 703. In step 703, The Artist proceeds with the instruction to divide the unit of The Story into three layers. Each layer has one or more their media content. The layers of The Story are at least three layers. The first layer comprises an introduction part of The Story. The diagram then branches to step 704. In step 704 a computer-implemented method allows a Visitor to access into the media content of the first layer, wherein The Visitor is using a second computer connected to the remote server. The method further continues to step 705. In step 705, the media content of the first layer is presented to The Visitor.

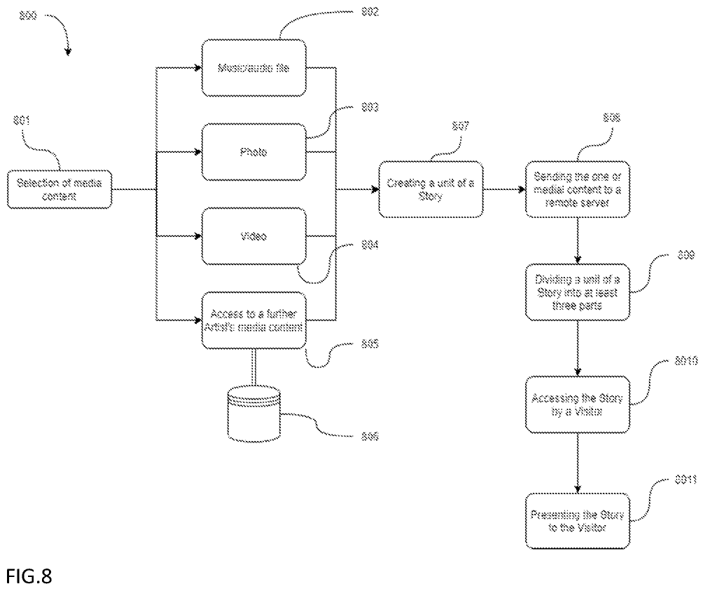

FIG. 8 shows a diagram 800 detailing a possible mode of operation of a method for uploading and/or crating the media content of creative art provided by an Artist. In Step 801 an item of the media content is selected to be uploaded and/or created based on the already uploaded media content. In some embodiment, the media content can be created media content provided by a further Artist upon request therefrom or upon request provided to the administrator as substantially described in connection with FIG. 7. The media content can be selected from several type of the media content, such as music/audio 802, or photo 803, video 804, for example. The shared layer can be also mix-type media available through an access to a further Artist's media content 805. The media content provided by a further Artist can be available to them through the database 806. The diagram then branches to step 807. In step 807 The Artist creates a unit of The Story from the mixture of the media content or shared layers. The diagram then branches to step 808. In step 808, The Artist sends the one or medial content, preferably mixed-type and more preferably shared-layer type media content, from the first computer device to a remote server via one or more methods of communication. By uploading and/or creating the media content onto the remote server, a unit Story is thereby provided. The diagram then branches to step 809. In step 809, The Artist proceeds with the instruction to divide the unit of The Story into three layers. Each layer has one or more their media content. The layers of The Story are at least three layers. The first layer comprises an introduction part of The Story. The diagram then branches to step 8010. In step 8010 a computer-implemented method allows a Visitor to access into the media content of the first layer, wherein The Visitor is using a second computer connected to the remote server as substantially described above. The method further continues to step 8011. In step 8011, the media content of the first layer is presented to The Visitor.

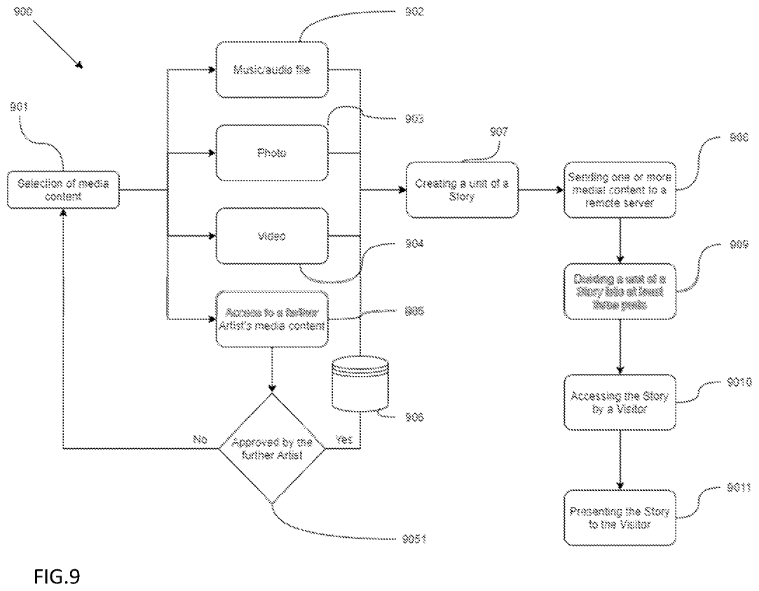

FIG. 9 shows a diagram 900 detailing a possible mode of operation of a method for uploading and/or crating the media content of creative art provided by an Artist. In Step 901 an item of the media content is selected to be uploaded and/or created based on the already uploaded media content. In some embodiment, the media content can be created media content provided by a further Artist upon request therefrom or upon request provided to the administrator as substantially described in connection with FIG. 7 and FIG. 8. The media content can be selected from several type of the media content, such as music/audio 902, or photo 903, video 904, for example. The shared layer can be also mix-type media available through an access to a further Artist's media content 905. The media content provided by a further Artist can be available to them through the database 906. The access to the database can be subject to approval 9051 by the administrator and/or the further Artist. The diagram then branches to step 907. In step 907 The Artist creates a unit of The Story from the mixture of the media content or shared layers. The diagram then branches to step 908. In step 908, The Artist sends the one or medial content, preferably mixed-type and more preferably shared-layer type media content, from the first computer device to a remote server via one or more methods of communication. By uploading and/or creating the media content onto the remote server, a unit Story is thereby provided. The diagram then branches to step 909. In step 909, The Artist proceeds with the instruction to divide the unit of The Story into three layers. Each layer has one or more their media content. The layers of The Story are at least three layers. The first layer comprises an introduction part of The Story. The diagram then branches to step 9010. In step 9010 a computer-implemented method allows a Visitor to access into the media content of the first layer, wherein The Visitor is using a second computer connected to the remote server as substantially described above. The method further continues to step 9011. In step 9011, the media content of the first layer is presented to The Visitor.

1. A computer-implemented method for creating and telling an audio and/or video story through sequential layers by an artist presented to a visitor, wherein the method comprising steps, in the following order:
a) uploading and/or creating media content to and/or by a first computer device by the artist on a remote server;
b) sending one or more medial content from the first computer device to the remote server through one or more methods of communication, wherein said one or more media content forms a unit of the story provided by the artist;
c) dividing said unit story into three acts according to the Three-act structure uploaded to the remote server, wherein the Three act-structure comprises a First Act, a Second Act and a Third Act; and wherein each Act or a at least a part of the Act is configured to be presented in a separate layer, wherein the layer is configured to represent a moment in the story; and wherein
i) the first layer comprises a part of the media content in accordance with The First Act; and
ii) the second layer comprises a part of the media content in accordance with The Second Act,; and
iii) the third layer comprises a part of the media content in accordance The Third Act;
thereby forming a unit of story having divided content, wherein each layer is subject to an administration permission; and
d) accessing to the divided content by a visitor by means of a second computer, wherein the second computer is accessing the media content comprised in the first layer from the remote server; and
e) presenting the first part of the media content on the second computer; and
requesting the visitor for a decision for the administrator permission for story continuation on a second computer;
g) receiving the visitor's decision by the administrator, wherein the server is selecting the corresponding layers from the unit of story divided in step c) and, upon the administrator decision, transmitting only corresponding layers to the second computer according to the visitor's decision in step f); and
h) presenting the layers comprising audio and/or video content from the layers received from the server on the second computer.

2. The method according to claim 1, wherein The First Act of the story comprises at least one act selected from the group of: Prolog, Status Quo, Beginning of a Story, Routine Killer, Timeout, Leaving the Comfort Zone.

3. The method according to claim 1, wherein The Second Act of the story comprises at least one act selected from the group of: Beginning of an Adventure, Twists, The Halfway Point, Obstacles, Crises, Aha-moment.

4. The method according to claim 1, wherein the third act of the story comprises at least one act selected from the group of: Road to Climax, Climax, Story Event, Aftermath.

5. The method according to claim 1, wherein the first layer is presenting to the visitor without any restriction to the media content.

6. The method according to claim 1, wherein the layers other than the first layer are providing in a restricted part of the remote server, wherein the media content of the other layers is accessible to the visitor upon administrator allowance.

7. The method according to claim 6, wherein the access to the restricted part is providing one-time or for a long-term period.

8. The method according to claim 1, wherein the second part of the media content is changing based on a response to the visitor's activity.

9. The method according to claim 1, wherein the step of creating the content by an artist comprises accessing to a further artist media content and creating a shared layer of the story, wherein the shared layer comprises the media content from at least two artists.

10. The method according to claim 1 further comprising accessing statistical data on visitors.

11. (canceled)

12. The method according to claim 1, wherein the third layer comprises plurality of alternative layers, wherein the alternative layers comprise plurality of alternative final scenes.

13. The method according to claim 1, wherein the second layer comprises plurality of alternative Story Events, wherein the alternative Story Events result into an alternative final scene.

14. The method according to claim 1, wherein media content is audio content only.

15. The method according to claim 14, wherein audio content is an audio album divided into at least three layers according to the Three-act structure.

16. The method according to claim 15, wherein at least one layer comprises at least one alternative.

17. The method according to claim 15, wherein a plurality of layers comprises plurality of alternatives.

18. The method according to claim 14, wherein the method comprises the step of accessing to a further artist's audio content and implementing the further artist's audio content into the audio album.

19. The method according to claim 15, wherein at least one layer is uploaded in a non-restricted are of an audio platform and/or at least one layer is uploaded in a restricted area of the audio platform.

20. A product-by-process according to claim 1.
